(19) United States
(12) Patent Application Publication
(10) Pub. No.: US 2004/0064346 A1
(43) Pub. Date: Apr. 1, 2004

(54) Method and system for gathering information relating to risks

(76) Inventors: Reto Schneider, Zurich (CH); Annabelle R. Hett, Weingarten (CH); Rudolf Frei, Naenikon (CH)

Correspondence Address: BARNES & THORNBURG, 600 ONE SUMMIT SQUARE, FORT WAYNE, IN, 46802

(21) Appl. No.: 10/262,341

(22) Filed: Oct. 1, 2002

(51) Int. Cl. G06F 17/60

(52) U.S. Cl. 705/4

(57) ABSTRACT

A method of systematically gathering information relating to risk perceptions includes the steps of providing a site on a network, allowing a selected group of users access to the site, receiving information from one or more of the users, the information including at least an identification of a specific risk and a rating of that risk, communicating the information received to a database, periodically extracting elements of information from the database and preparing a report based upon one or more of the extracted elements of information. A system for implementing the method includes a server for hosting the site, means for providing the users access to the site, a memory device, means for transferring information from the site to a database stored in the memory device, and means for periodically extracting information from the database and preparing the report.

### FIELD OF THE INVENTION

This invention relates generally to information gathering and analysis, and specifically to a method and system for gathering and analyzing information relating to perceptions of risk. In a particular application, the invention relates to a method and system for gathering and analyzing information relating to risks relevant to the development, marketing or administration of an insurance product.

### BACKGROUND OF THE INVENTION

Risk perceptions and analysis are relevant to many business processes. The manner in which risks are perceived is fundamental in some business settings. This is particularly so in the insurance industry, where insurable risks must be recognized, or perceived, and subsequently analyzed and quantified.

The perceptions of risks vary in different enterprises, cultures, geographical locations, and other settings. As the scope of business operations expand, such variations become increasingly relevant. The emergencies of new risks which impact existing business operations, or have implications for perspective operations, are also relevant in many industries, including the insurance industry. A methodology or platform to facilitate the exchange of information regarding perceptions of recognized and newly emerging risks could advantageously be used in a variety of settings.

### SUMMARY OF THE INVENTION

One embodiment of the present invention is a method of systematically gathering information relating to risk perceptions. The subject method comprises the steps of providing a site on a global information network, allowing access to the site by a selected group of users, receiving information via the network, from one or more of the users, communicating the information received from the users to a database, periodically extracting of information from the database, and preparing a report based upon the extracted elements of information. The information received includes at least an identification of a specific risk and a rating of that risk. In one embodiment, the extracted elements of information are tabulated in a spreadsheet. Access to the extracted elements of information is provided to one or more of the users via the network. Certain embodiments further include the step of automatically generating a message to an administrator upon the receipt of information from one of the users.

In one embodiment of the method of the present invention, the step of receiving information received from the users relates to a relative impact of a specific risk on an existing or prospective insurance product.

In certain embodiments, the method further comprises the step of providing, via the network, descriptive information relating to a specified risk for review by one or more of the users. These or other embodiments may also include the steps of providing a form for receiving comments or other feedback from a user relating to an identified risk, and/or providing a rating table to facilitate the rating of an identified risk by a user.

In one embodiment, the method further comprises the step of rating the periodically-extracted elements of information. This rating step is preferably performed, at least in part, by an expert (i.e., a human expert) having expertise in subject matter relating to the extracted information. One embodiment includes the additional step of preparing a report based upon at least one of the rated, extracted elements of information and relating to at least one specific risk.

Another aspect of the invention relates to a system for gathering information relating to emerging risks and for evaluating the potential impact of such risks on an insurance product. One embodiment of the system comprises a server for hosting a site on a global information network, means for providing a plurality of users access to the site, a memory device, means for transferring information from the site to a database stored in the memory device, and means for periodically extracting information from the database and preparing a report based on the extracted information. The site is configured to receive information relating to emerging risks from one or more of the users, via the network. In one embodiment, a feedback form is provided on the site to facilitate the receipt of comments relating to an identified risk from one or more of the system users. One embodiment also comprises a rating table to facilitate receipt of comments relating to an identified risk.

One embodiment of the system further comprises a spreadsheet program stored in the memory device, and a spreadsheet table for receiving the information extracted from the database. In one embodiment, the system further comprises means for providing access to the spreadsheet table to selected users, via the global information network.

Certain embodiments of the system may further comprise means for automatically communicating a message to a system administrator upon receipt of information from a user.

The system and method of the present invention may utilize the Internet as the global information network. Alternatively, an intranet, or other network, may be used.

Other aspects, advantages and novel features of the system and method of the present invention will become apparent from the following description of the invention when considered in conjunction with the accompanying drawings.

### BRIEF DESCRIPTION OF THE DRAWINGS

The present invention will be described hereafter with reference to the attached drawings which are given as a non-limiting example only, in which:

FIG. 1 is a flow diagram which illustrates embodiments of the system and method of the present invention.

FIG. 2 illustratively shows an example of a feedback form which may be used with one embodiment of the method and system of the present invention.

FIG. 3 illustratively shows an example of a rating form which may be used with one embodiment of the method and system of the present invention.

FIG. 4 illustratively shows the display of information made available to a user of one embodiment of the method and system of the present invention.

FIG. 5 illustratively shows a portion of a spreadsheet table which depicts extracted data for use with one embodiment of the method and system of the present invention.

### DESCRIPTION OF EMBODIMENTS OF THE INVENTION

The embodiment described herein is not intended to be exhaustive or to limit the invention to the precise form disclosed.

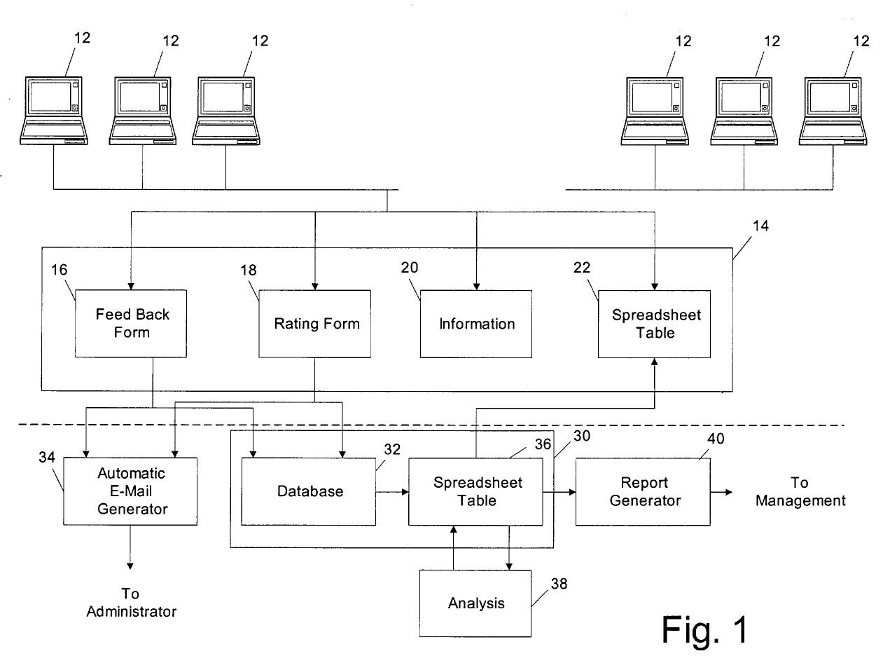

FIG. 1 is a flow diagram which illustrates embodiments of a system and method of the present invention. With reference to FIG. 1, a plurality of users 12 are connected to a network and provided access to a site, generally represented in FIG. 1 by block 14. In this illustrative embodiment, users 12 are PC users connected to a global information network, such as the Internet. Site 14 may be an Internet site hosted on a server connected to the same network (e.g., the Internet) as the users. Site 14 may be implemented using hypertext markup language (HTML), or other known programming languages and techniques. In the embodiment illustrated in FIG. 1, site 14 is hosted on a separate server than the server(s) used to host database 32, spreadsheet table 36, and other components to be described below. The respective servers may be connected via the same global information network connecting users 12 to site 14, or by dedicated hardwired or wireless connections. Alternatively, site 14 may be hosted on the same server used to host database 32, spreadsheet table 36, and other elements of the system.

Users 12 are preferably located in diverse locations geographically, so as to provide input regarding risk perceptions from different population centers. This may be important to the prompt detection of perceptions regarding risks which may emerge locally and then spread to other locations. Such geographical distribution of users may also be beneficial in understanding the impact of cultural factors upon perceptions of common or diverse risk.

It should be noted that, although geographically diverse users 12 are important in the context of certain embodiments of the invention illustrated and described in connection with FIGS. 1-5, certain applications of the invention may require different degrees or measures of diversity. For example, an embodiment used to gather perceptions regarding risks specific to a city, for instance, may be best served by a group of users representative of each section or area of the city to which the risk is relevant. Indeed, in such an example, input from users located in geographically remote areas may be irrelevant. In short, the desired degree and measure of diversity of the users will likely vary with particular risks and particular embodiments of the present invention.

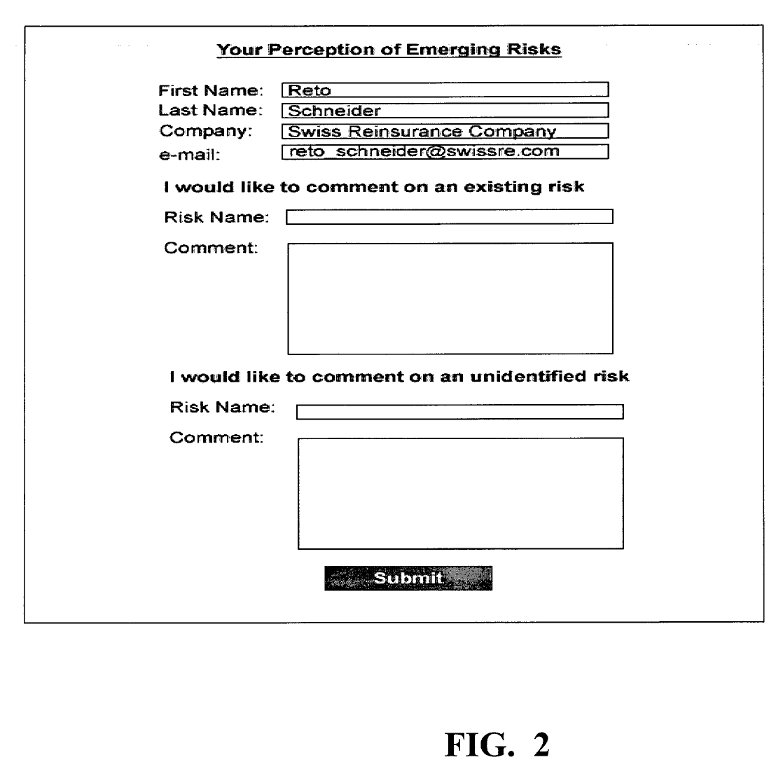

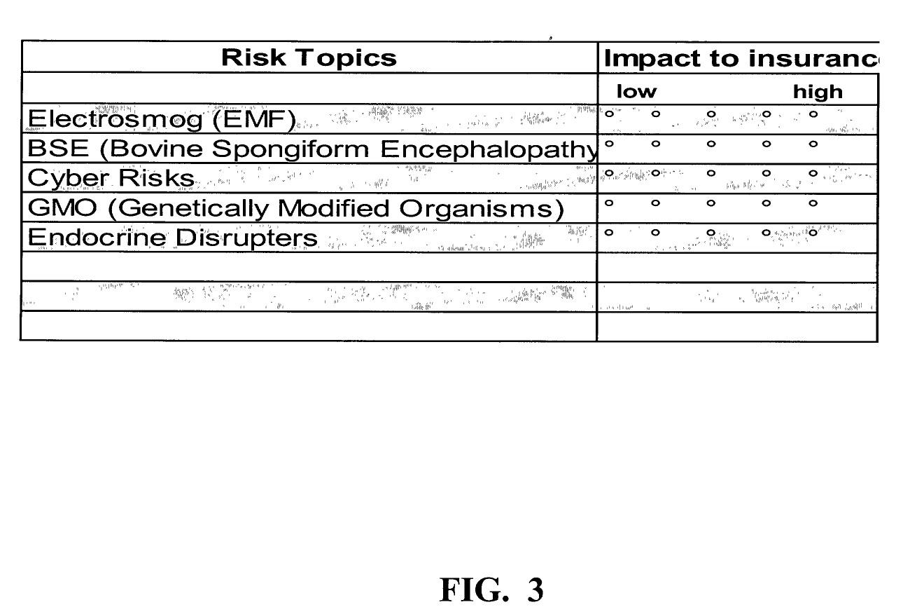

Site 14 includes a feedback form 16 used to facilitate the gathering of comments from users 12. An example of one embodiment of feedback form 16 is shown in FIG. 2 discussed below. Site 16 further includes rating form 18 used to facilitate the rating of risks identified by users 12. An example of rating form 18 is shown in FIG. 3 discussed below.

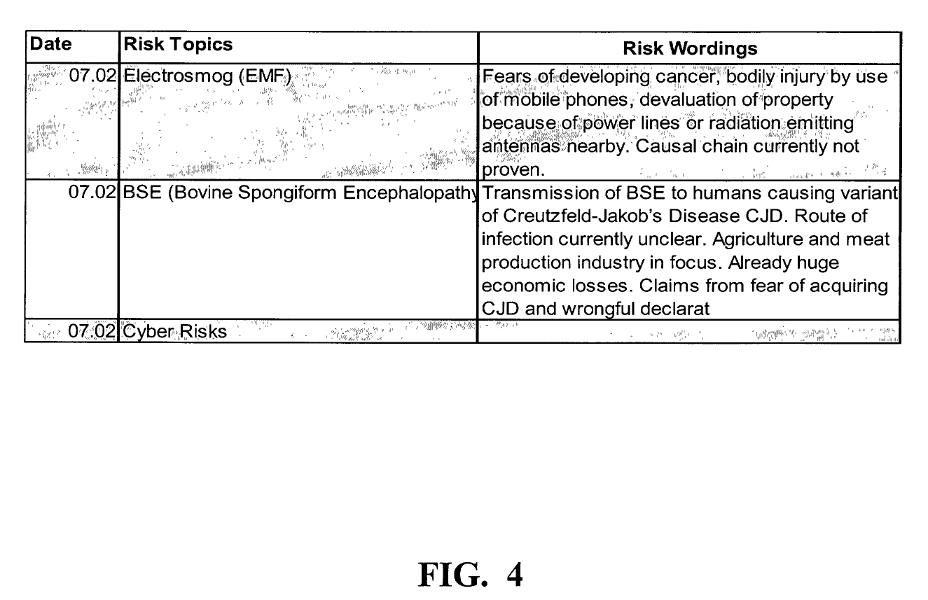

One embodiment of site 14 may also include descriptive information relating to a specified risk which is available for review and reference by users 12. Such information is represented by block 20 in the diagram of FIG. 1. An example of such information is illustrated by, and discussed below in connection with, FIG. 4.

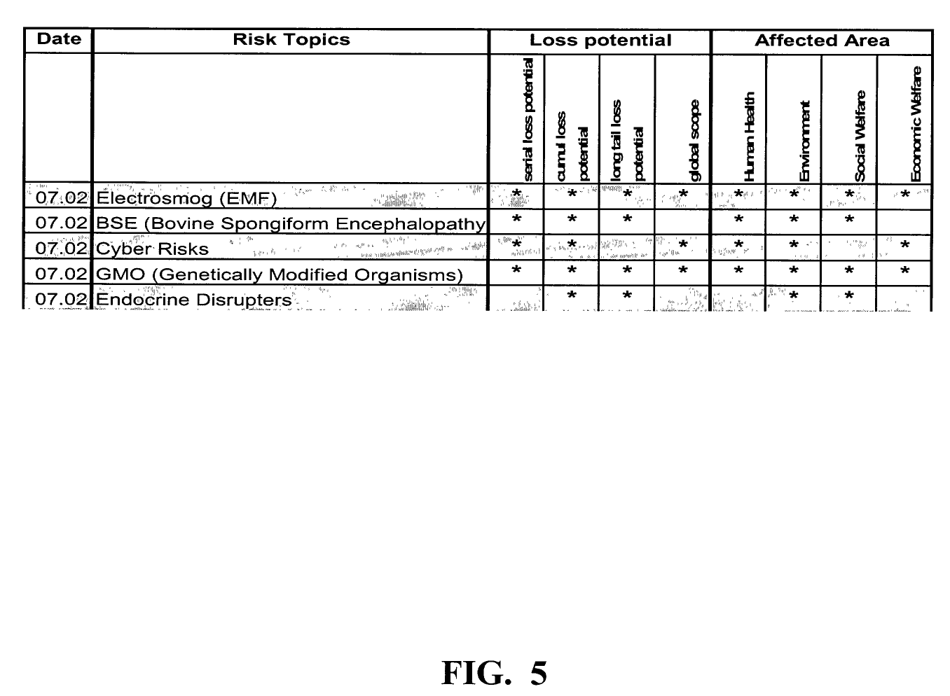

Site 14 further includes spreadsheet table 22 which comprises information periodically extracted from feedback and rating information provided by users 12, as will be described in additional detail below. Spreadsheet table 22 may be made available to all, or selected ones, of users 12 as circumstances may warrant. An illustrative example of a spreadsheet table suitable for use with the invention is shown in FIG. 5.

Site 14 is connected to, or is in communication with, a computer or server which includes a memory device 30 which is used to store a database 32. As information is received by feedback form 16 and/or rating form 18, such information is communicated to and stored in database 32. As such information is received, automatic e-mail generator 34 sends an e-mail to an administrator as notification of information receipt. Information from database 32 is periodically (e.g., weekly) extracted and stored by spreadsheet program in spreadsheet table 36. The information in spreadsheet table 36 is made available for internal analysis, as represented by block 38. The information in spreadsheet table 36, or selected portions thereof, is also periodically communicated to site 14, in the form of spreadsheet table 22. As previously noted, access to spreadsheet table 22 is made available to all or selected ones, of users 12.

The information in spreadsheet table 36 is used as a basis for the periodic generation of reports as represented by block 40. Such reports may be made available to management or others interested in the operation of the system or the information gathered from the various users.

FIG. 2 illustratively shows an example of a feedback form which may be used with one embodiment of the method and system of the present invention. As is apparent from FIG. 2, this particular form requests information regarding the identity of the user, requests identification of the specific risk to be commented on, and provides a place to receive such comments. In addition, the form of FIG. 2 provides space to identify and comment on a risk that has been previously unidentified (at least, in the context of the particular embodiment of the system) at the time of submission. The user identification information may be automatically filled in from login information stored within the system.

FIG. 3 illustratively shows an example of a rating form which may be used with one embodiment of the method and system of the present invention. As indicated in FIG. 3, a user who has logged into the system to offer comments and/or ratings regarding a specific risk (for instance, Cyber Risks) can rate the risk at any one of five levels ranging from low to high. This is simply one example of a form which may be used to facilitate such ratings. It will be apparent to those of skill in the art that numerous variations, including variations that are more or less general or specific, may be readily implemented.

FIG. 4 illustratively shows the display of information made available to a user of one embodiment of the method and system of the present invention. As indicated in FIG. 4, descriptions of specific risks are presented for the benefit of the user. Such descriptions may be substantially longer (or in some cases, shorter) than the illustrative descriptions shown in FIG. 4. Such descriptions may also include references or links to other sources of information on specific risks.

FIG. 5 illustratively shows a portion of a spreadsheet table which depicts extracted data for use with one embodiment of the method and system of the present invention. The elements of information presented in FIG. 5 represent a distillation of comments and ratings received from users, via feedback form 16 and rating form 18, and subsequently stored in database 32. As previously described, such information is periodically extracted from database 32 and presented in the form of a spreadsheet for analysis and review. In one embodiment of the invention, a Microsoft Excel® spreadsheet program is provided for purposes of constructing the table of FIG. 5. Tables such as the one shown in FIG. 5 are available for internal analysis 38 and report generation 40, and can be made available to users 12 via the global information network and site 14.

In addition to feedback form 16, rating form 18, information 20 and spreadsheet table 22, other features may be made available to users 12 of site 14. For example, relevant hypertext links may be provided to other sites on the network (on other networks). Instructions regarding use of the site may also be provided.

While this invention has been described as having exemplary embodiments, this description is not intended to be limiting. The claims are intended to cover variations, alternative uses, and adaptations utilizing the general concepts of the invention. Further, the claims are intended to cover such departures from the present disclosure as come within the known or customary practice within the art to which it pertains.

What is claimed is:

1. A method of systematically gathering information relating to risk perceptions, comprising the steps of:
a) providing a site on a global information network;
b) allowing access to the site by a selected group of users;
c) receiving information, via the network, from one or more of the users, said information including at least an identification of a specific risk and a rating of said specific risk;
d) communicating the information received from the users to a database;
e) periodically extracting elements of information from the data base; and
f) preparing a report based upon one or more of the extracted elements of information.

2. The method of claim 1, further comprising the steps of tabulating the extracted elements of information in a spread sheet, and providing one or more of the users access to the extracted elements of information via the network.

3. The method of claim 1, further comprising the step of automatically generating a message to an administrator upon receiving information from one of the users.

4. The method of claim 1, wherein the step of receiving information further comprises the step of receiving information relating to a relative impact of the specific risk on an insurance product.

5. The method of claim 1, wherein the global information network is an intranet.

6. The method of claim 1, wherein the global information network is the Internet.

7. The method of claim 1, further comprising the step of providing, via the network, descriptive information relating to a specified risk for review by one or more of the users.

8. The method of claim 1, further comprising the step of providing a form for receiving comments from a user relating to an identified risk.

9. The method of claim 1, further comprising the step of providing a rating table to facilitate the rating of an identified risk by a user.

10. The method of claim 1, further comprising the step of rating the periodically-extracted elements of information.

11. The method of claim 10, wherein the step of rating the periodically-extracted elements of information is performed, at least in part, by an expert in subject matter related to the extracted information.

12. The method of claim 10, further comprising the step of preparing a report based upon at least one of the rated, extracted elements of information and relating to at least one specific risk.

13. A system for gathering information relating to emerging risks and for evaluating the potential impacts of such risks on an insurance product, comprising:
a) a server for hosting a site on a global information network;
b) means for providing a plurality of users access to the site;
c) said site being configured to receive information relating to emerging risks from one or more of the users, via the network;
d) a memory device;
e) means for transferring information from the site to a data base stored in the memory device; and
f) means for periodically extracting information from the data base and preparing a report based on the extracted information.

14. The system of claim 13, wherein said site comprises a feedback form to facilitate receipt of comments relating to an identified risk.

15. The system of claim 13, wherein said site comprises a rating table to facilitate receipt of comments relating to an identified risk.

16. The system of claim 13, further comprising a spread sheet program stored in the memory device, and a spread sheet table for receiving the extracted information.

17. The system of claim 16, further comprising means for providing access to the spread sheet table to selected users, via the global information network.

18. The system of claim 13, further comprising means for automatically communicating a message to a system administrator upon receipt of information from a user.

19. The system of claim 13, wherein said global information network is an intranet.

20. The system of claim 13, wherein said global information network is the Internet.
